(19) United States
(12) Patent Application Publication
(10) Pub. No.: US 2025/0142284 A1
(43) Pub. Date: May 1, 2025

(54) DYNAMIC PORTABLE SPEAKER GROUPING

(71) Applicant: Bose Corporation, Framingham, MA (US)

(72) Inventors: Lauren Taylor Westendorf, Waltham, MA (US); Todd Richard Reily, North Reading, MA (US); Matthew Christopher Smith, Needham Heights, MA (US); Jenna Marie Duggan-Lykes, Hyde Park, MA (US)

(21) Appl. No.: 18/385,997

(22) Filed: Nov. 1, 2023

(51) Int. Cl. H04S 7/00; H04R 1/02

(52) U.S. Cl. CPC H04S 7/308; H04R 1/026; H04R 2420/07; H04S 2400/11; H04S 2400/13; H04S 2400/15

(57) ABSTRACT

Various implementations include systems and approaches for grouping speakers. In some cases, a method includes, configuring a first set of acoustic properties to be applied to an audio device in response to detecting an identifier for a given location; in response to detecting the identifier, automatically applying the first set of acoustic properties to the audio device for audio playback; and in response to no longer detecting the identifier, automatically applying a second set of acoustic properties to the audio device for audio playback, the second set of acoustic properties being different from the first set of acoustic properties in at least one aspect.

### TECHNICAL FIELD

This disclosure generally relates to audio systems. More particularly, the disclosure relates to controlling acoustic properties of an audio device based on a device identifier.

### BACKGROUND

Portable speakers such as portable home speakers can enable convenient, spontaneous creation of audio environments in many usage scenarios. However, conventional portable speakers can have shortcomings, particularly in terms of coordinating output with additional speakers in a group. For example, adding or removing portable speakers from a speaker group can be cumbersome and/or cause undesired output among speakers in the group.

### SUMMARY

All examples and features mentioned below can be combined in any technically possible way.

Various implementations include systems and approaches for grouping speakers. In some cases, a method includes: configuring a first set of acoustic properties to be applied to an audio device in response to detecting an identifier for a given location; in response to detecting the identifier, automatically applying the first set of acoustic properties to the audio device for audio playback; and in response to no longer detecting the identifier, automatically applying a second set of acoustic properties to the audio device for audio playback, the second set of acoustic properties being different from the first set of acoustic properties in at least one aspect.

In additional particular aspects, an audio device includes: an electro-acoustic transducer; and a processor coupled with the electro-acoustic transducer, the processor programmed to: configure a first set of acoustic properties to be applied to the audio device in response to detecting an identifier for a given location, in response to detecting the identifier, automatically apply the first set of acoustic properties to the audio device for audio playback at the transducer, and in response to no longer detecting the identifier, automatically apply a second set of acoustic properties to the audio device for audio playback at the transducer, the second set of acoustic properties being different from the first set of acoustic properties in at least one aspect.

In further particular aspects, a portable home speaker system includes: an accessory device, and a first audio device configured with a first set of acoustic properties to be applied in response to detecting an identifier of the accessory device, where the first audio device includes a processor programmed to, in response to detecting the identifier of the accessory device, automatically apply the first set of acoustic properties for audio playback; and in response to no longer detecting the identifier of the accessory device, automatically apply a second set of acoustic properties for audio playback, the second set of acoustic properties being different from the first set of acoustic properties in at least one aspect.

Implementations may include one of the following features, or any combination thereof.

In some cases, configuring the first set of acoustic properties includes assigning the given location to the identifier.

In various examples, the given location (or, location identity) is updated in response to moving the audio device to a distinct identifier in an environment.

In particular aspects, the given location is assigned as at least one of, an outdoor indicator, an indoor indicator, a floor within a building, a room within a building, or a position in a room within a building.

In some cases, the given location is used as an input for object-based audio output according to at least one of the first set of acoustic properties or the second set of acoustic properties.

In particular aspects, the first set of acoustic properties comprise aspects including, equalization, channel assignment, volume, role relative to another audio device, or grouping relative to another audio device.

In certain cases, configuring the first set of acoustic properties is performed using a software application running on a connected smart device.

In some aspects, the identifier is provided via a dock configured to hold the audio device.

In particular implementations, the identifier is associated with a group of audio devices in a location.

In particular aspects, automatically applying the first set of acoustic properties includes joining the audio device with the group of audio devices in the location.

In certain cases, joining the audio device with the group of audio devices includes coordinating audio output among the group of audio devices including the joined audio device. In particular cases, functions such as audio controls for the group of audio devices can be controlled by a centralized interface command. In certain cases, the centralized interface command can include a command at a single interface.

In some cases, coordinating audio output among the group of audio devices includes either, initiating audio output at additional audio devices in the group based on a current audio output from the audio device, or initiating audio output at the audio device based on a current audio output at the additional audio devices in the group. In some cases, initiating audio output at additional audio devices based on a current audio output from the audio device provides a perception that the audio spreads from the introduced audio device to the remaining speakers already in the location. In additional cases, initiating audio output at the introduced audio device based on a current audio output at the additional audio devices provides a perception that the audio spreads to the introduced audio device from the remaining speakers already in the location.

In particular aspects, automatically applying the second set of acoustic properties includes removing the audio device from the group of audio devices in the location.

In certain implementations, removing the audio device from the group of audio devices includes discontinuing audio output from the audio device while audio output continues with a remainder of the group of audio devices.

In some aspects, removing the audio device from the group of audio devices includes modifying audio output from the audio device such that the audio device plays as a stand-alone speaker.

In particular implementations, the identifier includes at least one of a Bluetooth (BT) identifier or a radio frequency (RF) identifier.

In certain aspects, the identifier includes a unique, non-writable identifier.

In some cases, the audio device is one of a plurality of audio devices each configured to automatically apply at least one of the first set of acoustic settings or the second set of acoustic settings in response to detecting the identifier.

In certain aspects, the plurality of audio devices are either, of a same make and a same model, or differing in at least one of make or model.

In particular implementations, the identifier is configured to work for only one of the plurality of audio devices at a time.

In some cases, the plurality of audio devices are substitutable for one another in working with the identifier.

In certain aspects, the accessory device includes a charging device.

In some implementations, the accessory device includes a docking station or an identification hub without charging capability.

In some aspects, the first set of acoustic properties are configured to include an assigned location of the accessory device in an environment.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including an accessory device and at least one audio device, according to various disclosed implementations.

FIG. 2 is flow diagram illustrating processes in a method according to various implementations.

FIG. 3 is an example interface chart for assigning devices to locations according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that configuring acoustic properties to be applied to an audio device based on detecting an identifier can enhance the user experience.

As noted herein, conventional portable speakers and related approaches for managing audio output from such speakers can fail to account for dynamic usage scenarios. For example, it can be cumbersome to join conventional portable speakers to an existing speaker grouping and/or separate portable speakers from a grouping once joined. Further, conventional portable speakers and related approaches can fail to adapt to movement of the portable speakers within a space occupied by other speakers.

In contrast to conventional approaches and systems, various implementations include approaches for applying distinct sets of acoustic properties to an audio device based on detecting an identifier for a given location. In certain cases, the identifier is of an accessory device, e.g., a charging device, assigned to a given location. In a particular implementation, the method includes configuring a first set of acoustic properties to be applied to an audio device in response to detecting an identifier for a given location. In response to detecting the identifier, the approach further includes automatically applying the first set of acoustic properties to the audio device for audio playback. In response to no longer detecting the identifier, the approach further includes automatically applying a second, distinct set of acoustic properties to the audio device for audio playback. In certain implementations, configuring the first set of acoustic properties includes assigning a location of the identifier (e.g., device) in an environment. In particular cases, the identifier is detected based on proximity and/or a physical coupling between the accessory device (or other device including the identifier) and the audio device. The approaches disclosed herein can enable application of distinct acoustic properties to an audio device, e.g., based on movement of the audio device within the environment and/or into/out of the environment.

Commonly labeled components in the FIGURES are considered to be substantially equivalent components for the purposes of illustration, and redundant discussion of those components is omitted for clarity.

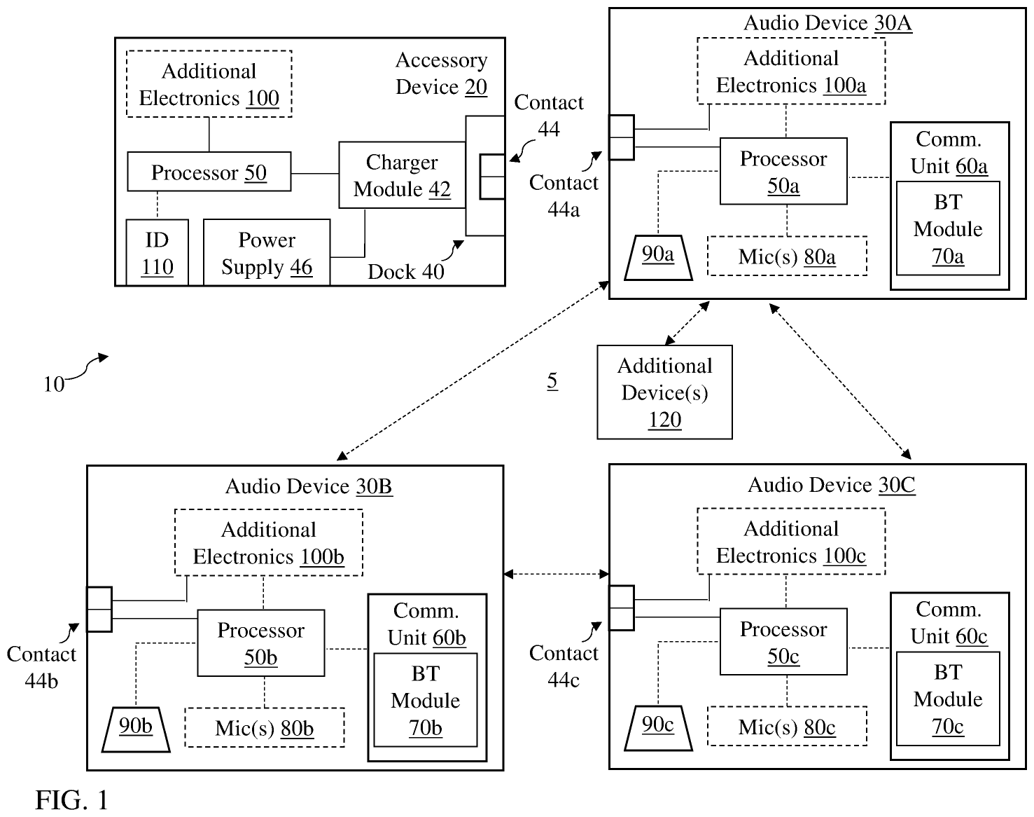

FIG. 1 shows an example of an environment (or, space) 5 including a system 10 including a set of devices according to various implementations. In various implementations, the devices shown in system 10 include an accessory device (or simply, device) 20 and an audio device 30 that is configured to interact with the device 20. In particular implementations, device 20 includes a charging device that is configured to charge (i.e., power) the audio device 30.

In a particular implementation, the device 20 includes a dock 40 for holding the audio device 30, e.g., a recess, opening, or protrusion for physically engaging the audio device 30 such as during charging. In some cases, the device 20 includes a charger module 42, as well as at least one physical (i.e., electrical) contact 44 for connecting with a corresponding contact 44a on the audio device 30. In particular cases, the charger module 42 is configured to wirelessly charge a device, e.g., audio device 30 via a wireless charging protocol such as radio frequency (RF). In certain cases, the device 20 further includes a power supply 46 for providing power to charge the audio device 30. In some aspects, the power supply 46 includes a battery and/or a hard-wired connector for drawing power from an outlet or another external power source (e.g., via a USB connection). In certain implementations, the device 20 also includes a processor 50 (or multiple processors 50) that can be configured for assignment of a location or identity of the device 20 as further described herein. The device 20 can include additional electronics 100 such as a power manager, memory, sensors (e.g., IMUs, accelerometers/gyroscope/magnetometers, optical sensors, voice activity detection systems), etc. Additionally, the processor 50 can be configured to receive inputs from one or more additional components in the device (e.g., charger module 42, contact(s) 44, power supply 46, and/or additional electronics 100) to detect proximity and/or charging status of the audio device 30, identify the audio device 30, and/or communicate with additional devices in the space 5. In certain examples, the additional electronics 100 in the device 20 can include a communications unit (e.g., wireless communications unit) such as those described with reference to the audio devices 30 herein.

While certain implementations are described as including a device 20 with charging capabilities (e.g., a charging dock), in various other implementations, the device 20 can include an identification hub without charging capability. In such implementations, the identification hub can include power storage such as a battery, and can be configured for placement in any number of locations in a space 5. In certain of these cases, the device 20 is not configured to charge the audio device 30, but can provide or otherwise facilitate detection functions and/or additional control functions described herein. These variations on device 20 can take any of a number of suitable form factors, e.g., coasters or discs, hooks, hangable tags, adhesive devices, etc. As noted herein, in any case, the device 20 can provide an identifier for a given location that enables automatic application of acoustic properties to the audio device(s) 30.

In certain cases, the space 5 includes a plurality of audio devices 30A, 30B, etc., that are capable of being connected with device 20. In further implementations, one or more of the audio devices 30 is configured to connect with the device 20, e.g., for charging. In certain cases, the plurality of audio devices 30A, 30B, 30C are either, of a same make and a same model, or differing in at least one of make or model. In various implementations, the identifier (e.g., device 20) is configured to work with a plurality of distinct audio devices (e.g., 30A, 30B, 30C) that differ in at least one of make or model. In various implementations, the accessory device 20 is configured to connect with only one of the plurality of audio devices 30 at a time. For example, accessory device 20 may be configured to charge only one of the audio devices 30 at a time, e.g., via engagement with the dock 40.

One or more of the audio devices 30 can include a portable speaker, such as a portable home speaker. It is understood that a “portable speaker” or a “portable home speaker” as described herein can refer to any of a number of speakers that are configured for wired and/or wireless operation, and are configured to change location. In certain cases, such speakers are labeled as “portable,” but this is not necessary in all implementations. Further, portable speakers and portable home speakers can be configured to charge in a dock (e.g., device 20), wirelessly charge, and/or remain connected to an external power source such as an outlet or additional device while outputting audio. Non-limiting examples of portable speakers provided by Bose Corporation (Framingham, MA, USA) can include the Bose Portable Smart Speaker, the Bose SoundLink Flex, the Bose SoundLink Micro, the Bose SoundLink Mini II, and/or the Bose SoundLink Revolve II (product names truncated for brevity). One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc.

A first one of the audio devices 30A is described herein as being configured to connect with device 20, however, it is understood that two or more of the audio devices 30 can also be configured to connect with device 20 and/or with additional similar devices 20, such as distinct charging devices in one or more locations. Two or more devices (e.g., audio devices 30) can communicate with one another using any communications protocol or approach described herein. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In certain cases, the audio device(s) 30 each include one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50a, 50b, 50c, the audio devices 30 can also include one or more microphones 80 (e.g., a microphone array), and a transducer 90 (e.g., an electro-acoustic transducer) for providing an audio output, e.g., in space 5. Further, the audio devices 30, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

In particular cases, the processor(s) 50 may provide, for example, for coordination of other components of the audio device(s) 30 and/or device 20, such as control of acoustic properties for audio playback at the audio device(s) 30. In various implementations, processor(s) 50 in audio device 30 include an accessory-based acoustic property control module which can include software and/or hardware for performing control processes described herein. For example, processor(s) 50 can include an accessory-based acoustic property control module in the form of a software stack having instructions for controlling functions in outputting audio based on detecting an identifier of the device 20 according to any implementation described herein.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 30 and/or additional device(s) such as smart devices (e.g., smartphones, tablets, smart watches) via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF) and/or a hard-wired connection, e.g., between any two or more devices.

In certain example implementations, additional devices 120 such as smart phones, smart watches, tablets, etc. in space 5 can include similar components (e.g., a processor 50 and communications unit 60) as the audio device(s) 30. Further, those additional devices 120 can include additional components that may not necessarily be present at the accessory device 20 (e.g., a transducer 90 and microphone(s) 80). Additional device(s) 120 can be configured to communicate with any device described herein. Further, in certain cases, distinct audio devices 30A, 30B can include distinct speakers in the space 5, and in particular cases, can include one or more portable speakers in the space 5.

With continuing reference to FIG. 1, in particular cases, the accessory device 20 can further include a device identifier 110 that is unique to the device 20 or the type of device 20. In some cases, the identifier 110 can be stored in memory at the device 20. In certain implementations, the identifier 110 includes a BT identifier and/or an RF identifier. In still further implementations, the identifier 110 includes a unique, non-writable identifier, which can include an identifier (ID), model type, and/or capabilities indicator, e.g., ID #X, hasNfc, hasMic, hasBattery. Audio device(s) 30 can be configured to detect the device identifier 110, e.g., via physical connection such as the contacts 44, and/or via wireless signals received via the communication unit 60. In certain cases, the audio devices 30 can only detect the device identifier 110 within close proximity (e.g., 10 centimeters (cm), 20 cm, 30 cm, 40 cm, or 50 cm) to the device 20. In particular cases, the audio device 30 only detects the device identifier 110 when the device 30 is within several centimeters or less of the device 20.

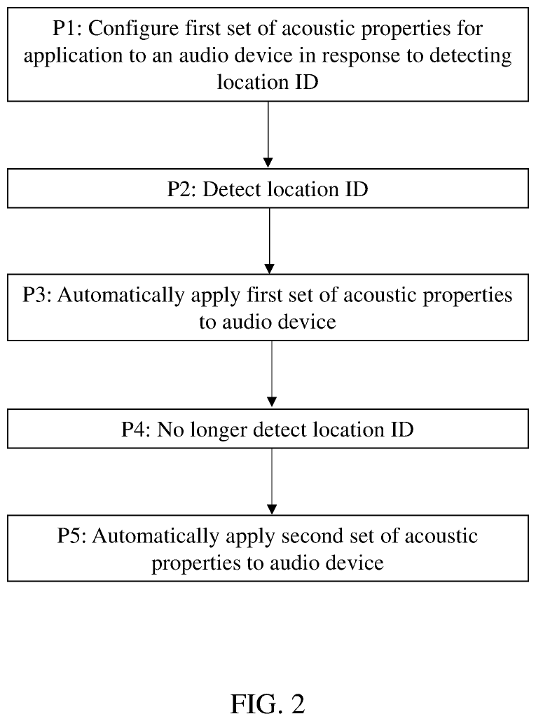

FIG. 2 is a flow diagram illustrating processes in a method of controlling audio output at audio device(s) 30 based on detection of the device identifier 110 according to various implementations. In a first process (P1), a first set of acoustic properties are configured for application to an audio device 30 in response to detecting the identifier 110 for a given location, e.g., the location of the device 20. In certain cases, configuring the first set of acoustic properties is performed using a software application running on a connected smart device, e.g., another device 120 in the space 5. In some examples, the software application includes an audio configuration engine for the audio device 30, which can enable acoustic property selection, profile building and/or selection, etc. In certain cases, the first set of acoustic properties includes aspects such as: equalization, channel assignment, volume, role relative to another audio device, or grouping relative to another audio device. In some aspects, the first set of acoustic properties are configured to include an assigned location of the identifier 110.

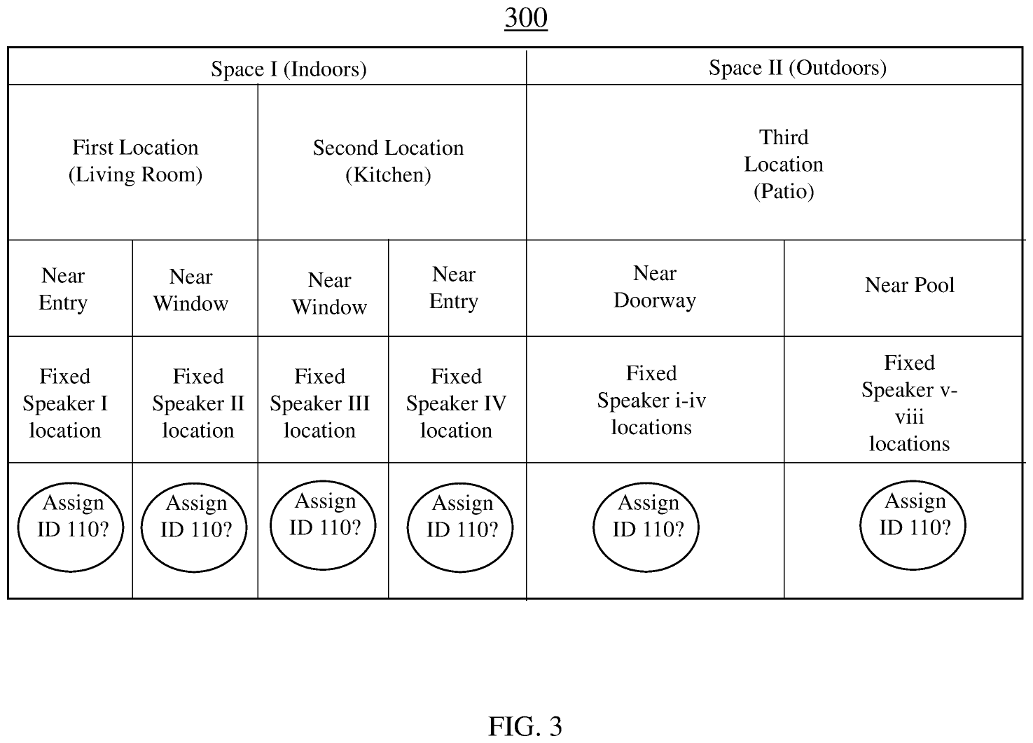

In particular implementations, configuring the first set of acoustic properties for application in response to detecting the identifier 110 includes assigning a location of the device 20 in an environment. For example, a software application can enable assigning a location of device 20 in a space 5, sub-space/location and/or among different spaces. FIG. 3 depicts an example assignment chart 300 that can be displayed on an interface at an additional device 120 (e.g., smart phone, tablet, etc.) for configuring acoustic properties and/or location assignment of identifiers 110 (e.g., via associated devices 20) in a space. The examples in chart 300 relate to spaces and locations in a home or residence, but various additional examples are possible, e.g., in an office building, house of worship, restaurant, entertainment venue, etc. In the example depicted in FIG. 3, distinct spaces (e.g., indoors v. outdoors) can be further defined by locations within a space (e.g., living room v. kitchen, or patio). Proximity designations such as “near entry,” “near window,” or “near doorway” can be used, in some examples, to designate areas within a location. Specific locations within a space can be further designated by one or more conventional triangulation techniques and/or signal strength detection algorithms, e.g., using Wi-Fi, RF, BT, etc. In the example chart 300, the interface enables location assignment for one or more IDs 110 (e.g., via accessory devices 20), e.g., near the window in the living room, or near the doorway on the patio, or near the entry in the kitchen. In some cases, the interface enables location assignment for a plurality of IDs 110 (and associated accessory devices 20). Further, as described herein, location assignment for the ID 110 can be performed during setup of the accessory device 20, or during a restart of the device 20 such as when the device is plugged into a power source such as an outlet.

In certain examples, the location of the ID 110 (and associated device 20) is assigned as at least one of, an outdoor indicator, an indoor indicator, a floor within a building, a room within a building, or a position in a room within a building. In further examples, location of the device 20 is used to control object-based audio output according to a set of acoustic properties. As described herein, in various examples, the location (or, location identity) of an audio device (e.g., audio device 30) is updated in response to moving the audio device 30 to a distinct ID 110 in an environment.

Returning to FIG. 2, in a second process (P2) the processor 50 at an audio device 30 (e.g., audio device 30A) can detect the identifier 110 (e.g., of device 20), for example, when the audio device 30 is placed in proximity of device 20 such as for charging. In some examples, a user may dock the audio device 30 to the device 20 for charging. In other cases, the audio device 30 may be configured to wirelessly charge via the device 20. As described herein, identifier 110 can be detected with the communications unit 60 at audio device 30 (e.g., if identifier 110 is a BT identifier and/or an RF identifier) and/or via physical connection at the contact 44. In response to detecting the identifier 110, processor 50 at the audio device 30 is configured to automatically apply the first set of acoustic properties (e.g., equalization, channel assignment, volume, role relative to another audio device, or grouping relative to another audio device for audio playback). That is, detection of the device identifier 110 causes the processor 50 to automatically apply the first set of acoustic properties, i.e., without additional user action or intervention. In certain cases, the first set of acoustic properties can be defined by the user, e.g., at a setup phase, based on location of the ID 110 in the space 5, and/or intended usage of the audio device proximate the ID 110 (e.g., for music output v. multimedia audio output).

In certain examples, acoustic properties (e.g., equalization, channel assignment, volume, role relative to another audio device, or grouping relative to another audio device for audio playback) can be defined by one or more attributes, at least some of which are adjustable. In certain non-liming examples, acoustic properties can be controlled according to attributes such as:

I) Equalization: bass, mid-range, and/or treble output can be adjustable to complement nearby audio devices. For example, when the accessory 20 no longer detects proximity of an audio device (e.g., audio device 30A), such as when the audio device is undocked, that audio device 30A provides output with an individually calibrated equalization level. Similar equalization adjustments can be made to other audio devices (e.g., audio device(s) 30B, 30C) when undocked, e.g., not proximate to accessory 20. In these examples, when audio devices (e.g., audio devices 30A, 30B) are outputting audio together (e.g., while docked, or otherwise in proximity to accessory device(s) 20), one audio device (e.g., audio device 30B) can increase its bass output and decrease its treble output, e.g., to provide an immersive multi-speaker experience.

II) Channel: when the accessory 20 no longer detects proximity of an audio device (e.g., audio device 30A), such as when the audio device is undocked, audio device 30A can output all the channels of a given audio source. In these examples, when the audio device 30A is detected as proximate the accessory 20 (e.g., docked), the processor 50 transitions to output one or a subset of channels at the audio device 30A to complement with other audio devices (e.g., audio device(s) 30B, 30C) playing one or more other channels, e.g., to provide an immersive multi-speaker experience.

III) Volume: in response to an audio device (e.g., audio device 30A) being added to a grouping (e.g., audio device(s) 30B, 30C), such as via detection of proximity by accessory 20, the processor 50 increases or decreases the volume of audio output at the added audio device 30A or the other (prior-connected) audio devices 30B, 30C to maintain a perceived consistent volume level. In this example, the processor 50 can decrease the volume of audio output at prior-grouped audio devices 30B, 30C and increase the volume of audio output at the added audio device 30A. Further, in response to an audio device (e.g., audio device 30A) being removed from a grouping (e.g., with audio device(s) 30B, 30C), such as via no longer detecting proximity by accessory 20, the processor 50 increases or decreases the volume of audio output at the added audio device 30A or the other (prior-connected) audio devices 30B, 30C to maintain a perceived consistent volume level. In this example, the processor 50 may increase the volume of audio output at the prior-grouped audio devices 30B, 30C and decrease the volume of audio output at the removed audio device 30A, e.g., stopping audio output at audio device 30A.

IV) Role: in certain cases, processor 50 can adjust the role of an audio device 30A such that the audio device 30A outputs audio as an accessory speaker to another audio device (e.g., a soundbar such as audio device 30C) when the audio device 30A is docked (e.g., proximate to accessory 20). In such cases, the audio device 30A outputs audio as an accessory speaker to audio device 30A when docked (e.g., defaults to accessory mode, and is not individually targetable via communication unit 60a, such as via Wi-Fi or BT). In these cases, when the audio device 30A is not proximate accessory 20 (e.g., undocked), the audio device 30A outputs audio as an independently targetable individual speaker.

V) Grouping: as noted further herein, an audio device (e.g., audio device 30A) can be joined to, or removed from a group based on detected proximity to accessory device 20.

In various implementations, once the processor 50 no longer detects the identifier 110 (P4), the processor 50 automatically applies a second, distinct set of acoustic properties to the audio device 30 (P5). As with process P3 (application of first set of acoustic properties), application of the second set of acoustic properties can be performed by processor 50 automatically, i.e., without additional user action or intervention. As also noted herein, the second set of acoustic properties differs in at least one aspect (e.g., equalization, channel assignment, volume, role relative to another audio device, or grouping relative to another audio device for audio playback) from the first set of acoustic properties.

With continuing reference to FIGS. 1-3, in various implementations, the ID 110 is associated with a group of audio devices 30 in a location. For example, the ID 110 can be assigned to a location where a plurality of audio devices 30 are located, and in some cases, are also commonly assigned. In particular cases, the audio devices 30 can include fixed audio devices in a given location. In the example chart 300, a first fixed speaker (I) and a second fixed speaker (II) are in a first location such as a living room. in another example, fixed speakers (i)-(viii) are in a third location such as a patio area. In particular cases, assigning the ID 110 to a location with other audio devices 30, associates that ID 110 with those other audio devices 30. In such scenarios, the ID 110 (e.g., and corresponding device 20) becomes associated with the group of audio devices 30 in the location. In further examples, multiple IDs 110 (and corresponding devices) can be assigned to a location and/or a group of audio devices 30. For example, two or more IDs 110 can be assigned to the living room location and thereby associated with the first fixed speaker (I) and the second fixed speaker (II).

A particular example is applicable using the depiction of audio devices 30A-C in FIG. 1. In this case, ID 110 is assigned to a location (e.g., space 5 such as a living room) that includes one or more audio devices such as fixed audio devices 30B, 30C. Those fixed audio devices 30B, 30C can include fixed entertainment system speakers or a set of smart speakers in a semi-permanent location. When the ID 110 is assigned to the location, that ID 110 (and corresponding device 20) is associated with the group of audio devices 30 in the location, e.g., device 20 is associated with audio devices 30B, 30C. In this example scenario, audio device 30A is a portable speaker that a user wishes to bring into the space 5, e.g., to continue existing audio output at that portable speaker 30A, to join with existing audio output from audio devices 30B, 30C, or to connect with audio devices 30B, 30C to coordinate new audio output. With reference to FIGS. 1 and 2, in certain cases, automatically applying the first set of acoustic properties (P3) includes joining the audio device (e.g., portable audio device 30A) with the group of audio devices (e.g., 30B, 30C) in the location in response to detecting the ID 110. In certain of these examples, joining the audio device 30A with the group of audio devices 30B, 30C includes coordinating audio output among the group of audio devices that now includes audio device 30A.

In some cases, coordinating audio output among the group of audio devices 30A, 30B, 30C includes either, a) initiating audio output at additional audio devices 30B, 30C in the group based on a current audio output from the audio device 30A, or b) initiating audio output at the audio device 30A based on a current audio output at the additional audio devices 30B, 30C in the group.

In some cases, initiating audio output at the additional audio devices 30B, 30C based on a current audio output from the audio device 30A provides a perception that the audio spreads from the introduced audio device 30A to the remaining speakers 30B, 30C already in the location (e.g., space 5). For example, the user may be listening to audio such as music at the portable speaker 30A in another location (e.g., outdoors), and wish to bring that music with her when moving indoors (e.g., to her kitchen). The kitchen may already have speakers such as permanent speakers or other portable speakers located therein. In this scenario, the user brings her portable speaker 30A indoors while current audio output is provided by the portable speaker 30A, and once the portable speaker 30A detects the identifier 110 (e.g., once device 20 is docked or begins charging connection), processor 50 at audio device 30A automatically communicates with other audio devices 30B, 30C to initiate coordinated audio output at the additional audio devices 30B, 30C in addition to the audio output at audio device 30A. In such cases, audio output continues at audio device 30A and is initiated at audio devices 30B, 30C.

In additional cases, initiating audio output at the introduced audio device 30A based on a current audio output at the additional audio devices 30B, 30C provides a perception that the audio spreads to the introduced audio device 30A from the remaining speakers 30B, 30C already in the location (e.g., space 5). For example, the user may be listening to audio such as an audio book at fixed speakers 30B, 30C in her living room, and wish to bring the portable speaker 30A into the living room from another location (e.g., her library), providing a more immersive audio experience. In this scenario, the user brings her portable speaker 30A to the living room while current audio output is provided by (e.g., fixed) speakers 30B, 30C, and once the portable speaker 30A detects the identifier 110 (e.g., once device 20 is docked or begins charging connection), processor 50 at audio device 30A automatically communicates with other audio devices 30B, 30C to initiate coordinated audio output at the portable audio device 30A in addition to the audio output at audio devices 30B, 30C. In such cases, audio output continues at audio devices 30B, 30C and is initiated at audio device 30A.

With reference to FIGS. 1 and 2, in certain cases, automatically applying the second set of acoustic properties (P5) includes removing the audio device (e.g., portable audio device 30A) from the group of audio devices (e.g., 30B, 30C) in the location in response to no longer detecting the ID 110. In certain of these examples, removing the audio device 30A from the group of audio devices 30B, 30C includes discontinuing audio output from the audio device 30A while audio output continues with a remainder of the group of audio devices (e.g., audio devices 30B, 30C). In certain other examples, removing the audio device 30A from the group of audio devices 30B, 30C includes modifying audio output from the audio device 30A such that the audio device 30A plays as a stand-alone speaker. Distinctions in applying the second set of acoustic properties can be based on user settings, profile settings, device type, and/or usage scenarios. In one example, e.g., where the audio device 30A spreads the audio to the additional audio devices 30B, 30C when introduced to the room, when that audio device 30A is removed from the group including audio devices 30B, 30C (e.g., user takes audio device 30A out of the room), modifying the audio output is performed such that the audio device 30A plays as a stand-alone speaker. In another example, e.g., where audio from the additional devices 30B, 30C spreads to the introduced audio device 30A, when the audio device 30A is removed from the group including audio devices 30B, 30C (e.g., user takes audio device 30A out of the room), audio output from the audio device 30A is discontinued while audio output continues with audio devices 30B, 30C.

In still further examples, an audio device 30A such as a portable speaker can be used to control a set of accessory speakers. In this case, accessory speakers cannot output audio without a controlling audio device, or hub device such as device 20. Using the depiction in FIG. 1, audio devices 30B, 30C, in simplified form, could be accessory speakers in a space 5. In this example, in response to detecting audio device 30A in space 5 (e.g., via proximity to device 20), the accessory speakers (30B, 30C) join the audio device 30A to output coordinated audio. For example, if the audio device 30A is outputting audio and is transported into space 5 (e.g., detected by device 20), the accessory speakers (30B, 30C) will initiate audio output in coordination with the audio output from audio device 30A. In these scenarios, when the audio device 30A is removed from the device 20, the accessory speakers (30B, 30C) return to idle.

In another example, as noted herein, audio devices (e.g., audio devices 30A, 30B, 30C) can include features of the accessory device 20, e.g., ID 110 and related programming, to enable proximity-based control of audio output without necessarily requiring detection of proximity to the accessory device 20. In these cases, control functions described herein relative to proximity to an accessory device 20 can be executed by a processor (e.g., processor 50 at an audio device 30) based on detected proximity to another audio device in space 5. For example, an audio device 30B can detect proximity to audio device 30A in space 5 and processor 50b can perform functions to group or ungroup audio device 30B with audio device 30A, and/or control other acoustic properties such as equalization, channel assignment, volume, and/or role relative to audio device 30A. In certain of these cases, acoustic properties can be controlled with a multi-factor actuation approach, such as requiring detected proximity between devices (e.g., audio devices 30A, 30B) and an interface input. For example, the processor 50b can adjust acoustic properties such as grouping, volume, or channel assignment based on detecting proximity between audio devices 30A, 30B and receiving an interface input (e.g., via additional electronics 100b) to trigger a proximity-based acoustic property adjustment. In certain cases, audio device(s) 30 can include an interface button or other input that enables proximity-based controls when another audio device 30 is detected within the proximity range, e.g., as described relative to accessory 20 herein. In additional cases, the processor 50b can adjust acoustic properties in response to detecting proximity to audio device 30A without user interaction, e.g., without requiring a user interface command.

In any case, the systems and approaches described according to various implementations have the technical effect of enhancing speaker control, in particular, control of a portable speaker in dynamic grouping scenarios. Using an accessory device identifier to group and un-group portable speakers can provide an efficient, effective mechanism for automatically applying acoustic properties to an audio device. In certain cases, the device identifier-based approach for controlling acoustic properties and/or groupings can enable smooth transitions between operating modes and usage scenarios. Further, the device identifier-based approaches described herein allow for multiple portable devices (e.g., audio devices) to be used interchangeably within immersive groups, e.g., dynamically assuming roles assigned by an accessory device (or, hub). These approaches offer flexibility and versatility, and reduce friction in coordinating audio output with distinct audio devices that may be of a same make/model.

Various wireless connection scenarios are described herein. It is understood that any number of wireless connection and/or communication protocols can be used to couple devices in a space, e.g., space 5 (FIG. 1). Examples of wireless connection scenarios and triggers for connecting wireless devices are described in further detail in U.S. patents application Ser. Nos. 17/714,253 (filed on Apr. 4, 2022) and 17/314,270 (filed on May 7, 2021), each of which is hereby incorporated by reference in its entirety).

It is further understood that any RF protocol could be used to communicate between devices according to implementations, including Bluetooth, Wi-Fi, or other proprietary or non-proprietary protocols. In implementations that utilize Bluetooth LE Audio, a unicast topology could be used for a one-to-one connection between speakers and/or devices in space 5. In some implementations, an LE Audio broadcast topology (such as Broadcast Audio) could be used to transmit one or more sets of audio data to multiple sets of speakers.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the coordinated audio output aspects according to the approaches described above. In particular cases, functions such as audio controls for a group of audio devices can be controlled by a centralized interface command, e.g., a command at an interface on one of the audio devices (e.g., audio device(s) 30A, 30B, 30C), an interface at the accessory device 20, and/or an interface at additional device 120. For example, a software module (e.g., an App) at the additional device 120 can be used to control audio output to an entire group of audio devices while grouped. In certain cases, the centralized interface command can include a command at a single interface.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A method comprising:
configuring a first set of acoustic properties to be applied to an audio device in response to detecting an identifier for a given location;
in response to detecting the identifier, automatically applying the first set of acoustic properties to the audio device for audio playback; and
in response to no longer detecting the identifier, automatically applying a second set of acoustic properties to the audio device for audio playback, the second set of acoustic properties being different from the first set of acoustic properties in at least one aspect.

2. The method of claim 1, wherein configuring the first set of acoustic properties includes assigning the given location to the identifier.

3. The method of claim 2, wherein the given location is assigned as at least one of,
an outdoor indicator, an indoor indicator, a floor within a building, a room within a building, or a position in a room within a building.

4. The method of claim 2, wherein the given location is used as an input for object-based audio output according to at least one of the first set of acoustic properties or the second set of acoustic properties.

5. The method of claim 1, wherein the first set of acoustic properties comprise aspects including,
equalization, channel assignment, volume, role relative to another audio device, or grouping relative to another audio device.

6. The method of claim 1, wherein configuring the first set of acoustic properties is performed using a software application running on a connected smart device.

7. The method of claim 1, wherein the identifier is provided via a dock, the dock configured to hold the audio device.

8. The method of claim 1, wherein the identifier is associated with a group of audio devices in a location.

9. The method of claim 8, wherein automatically applying the first set of acoustic properties includes joining the audio device with the group of audio devices in the location.

10. The method of claim 9, wherein joining the audio device with the group of audio devices includes coordinating audio output among the group of audio devices including the joined audio device.

11. The method of claim 10, wherein coordinating audio output among the group of audio devices includes either,
initiating audio output at additional audio devices in the group based on a current audio output from the audio device, or
initiating audio output at the audio device based on a current audio output at the additional audio devices in the group.

12. The method of claim 9, wherein automatically applying the second set of acoustic properties includes removing the audio device from the group of audio devices in the location.

13. The method of claim 12, wherein removing the audio device from the group of audio devices includes discontinuing audio output from the audio device while audio output continues with a remainder of the group of audio devices.

14. The method of claim 12, wherein removing the audio device from the group of audio devices includes modifying audio output from the audio device such that the audio device plays as a stand-alone speaker.

15. The method of claim 1, wherein the identifier includes at least one of a Bluetooth (BT) identifier or a radio frequency (RF) identifier.

16. The method of claim 1, wherein the identifier includes a unique, non-writable identifier.

17. The method of claim 1, wherein the audio device is one of a plurality of audio devices each configured to automatically apply at least one of the first set of acoustic settings or the second set of acoustic settings in response to detecting the identifier.

18. The method of claim 17, wherein the plurality of audio devices are either,
of a same make and a same model, or
differing in at least one of make or model.

19. The method of claim 17, wherein the identifier is configured to work for only one of the plurality of audio devices at a time.

20. The method of claim 19, wherein the plurality of audio devices are substitutable for one another in working with the identifier.

21. An audio device, comprising:
an electro-acoustic transducer; and
a processor coupled with the electro-acoustic transducer, the processor programmed to:
configure a first set of acoustic properties to be applied to the audio device in response to detecting an identifier for a given location,
in response to detecting the identifier, automatically apply the first set of acoustic properties to the audio device for audio playback at the transducer, and
in response to no longer detecting the identifier, automatically apply a second set of acoustic properties to the audio device for audio playback at the transducer, the second set of acoustic properties being different from the first set of acoustic properties in at least one aspect.

22. The audio device of claim 21, wherein the identifier is provided via a dock, the dock configured to hold the audio device.

23. The audio device of claim 21, wherein configuring the first set of acoustic properties includes assigning the given location to the identifier.

24. The audio device of claim 21, wherein the given location is assigned as at least one of,
an outdoor indicator, an indoor indicator, a floor within a building, a room within a building, or a position in a room within a building.

25. The audio device of claim 21, wherein the given location is used as an input for object-based audio output according to at least one of the first set of acoustic properties or the second set of acoustic properties.
